(19) United States
(12) Patent Application Publication
(10) Pub. No.: US 2026/0228479 A1
(43) Pub. Date: Aug. 6, 2026

(54) LOCATION-TRACKABLE BANKING CARD AND METHOD THEREFOR

(71) Applicant: Lindsey Clayton, Charlemont (AU)

(72) Inventor: Lindsey Clayton, Charlemont (AU)

(21) Appl. No.: 19/046,981

(22) Filed: Feb. 6, 2025

(51) Int. Cl. G06K 19/07

(52) U.S. Cl. CPC G06K 19/0716; G06K 19/0702

(57) ABSTRACT

A location-trackable banking card includes a card body, a magnetic strip, and a bank card chip embedded in the card body. A printed circuit board is positioned in the card body. A microcontroller is mounted on the printed circuit board. A GPS chip is mounted on the printed circuit board. The GPS chip is connected to the microcontroller to control intermittent operation of the GPS chip to receive location data from a GPS network. A SIM module is mounted on the printed circuit board. The SIM module is connected to the microcontroller to control operation of the SIM module to send location data over cellular networks. An antenna is positioned in the card body and connected to the GPS chip and the SIM module. A battery is positioned in the card body and connected to the printed circuit board to supply power.

### (b) CROSS-REFERENCE TO RELATED APPLICATIONS

Not Applicable

### (c) STATEMENT REGARDING FEDERALLY SPONSORED RESEARCH OR DEVELOPMENT Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to banking cards and more particularly pertains to a new location-trackable banking card for tracking the location of the bank card via global positioning system (GPS) technology and subscriber identity module (SIM) technology to help prevent theft and secure return of banking cards, as well as provide another way to track the location of a user of a banking card, whether the owner of the card or another party.

### (2) Description of Related Art including information disclosed under 37 CFR 1.97 and 1.98.

The prior art relates to banking cards and similar structures that include GPS technology to track the location. The prior art, as best understood, does not disclose a banking card that includes a SIM module for transmission of location data received from the GPS over cellular networks.

### (h) BRIEF SUMMARY OF THE INVENTION

An embodiment of the disclosure meets the needs presented above in a location-trackable banking card generally comprising a card body having a front face and a rear face. A magnetic strip is attached to the rear face of the card body. A bank card chip is embedded in the card body. A printed circuit board is positioned in the card body. A microcontroller is positioned in the card body and mounted on the printed circuit board. A GPS chip is positioned in the card body and mounted on the printed circuit board. The GPS chip is connected to the microcontroller to control intermittent operation of the GPS chip to receive location data from a GPS network. A SIM module is positioned in the card body and mounted on the printed circuit board. The SIM module is connected to the microcontroller to control operation of the SIM module to send location data over cellular networks. An antenna is positioned in the card body and connected to the GPS chip and the SIM module. A battery is positioned in the card body and connected to the printed circuit board to supply power.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(s)

The disclosure will be better understood and objects other than those set forth above will become apparent when consideration is given to the following detailed description thereof. Such description makes reference to the annexed drawings wherein: FIG. 1 is a perspective view of a location-trackable banking card according to an embodiment of the disclosure.

FIG. 2 is a front view of an embodiment of the disclosure.

FIG. 3 is a rear view of an embodiment of the disclosure.

FIG. 4 is a perspective view of an embodiment of the disclosure in use.

FIG. 5 is a block diagram of components of an embodiment of the disclosure.

### (j) DETAILED DESCRIPTION OF THE INVENTION

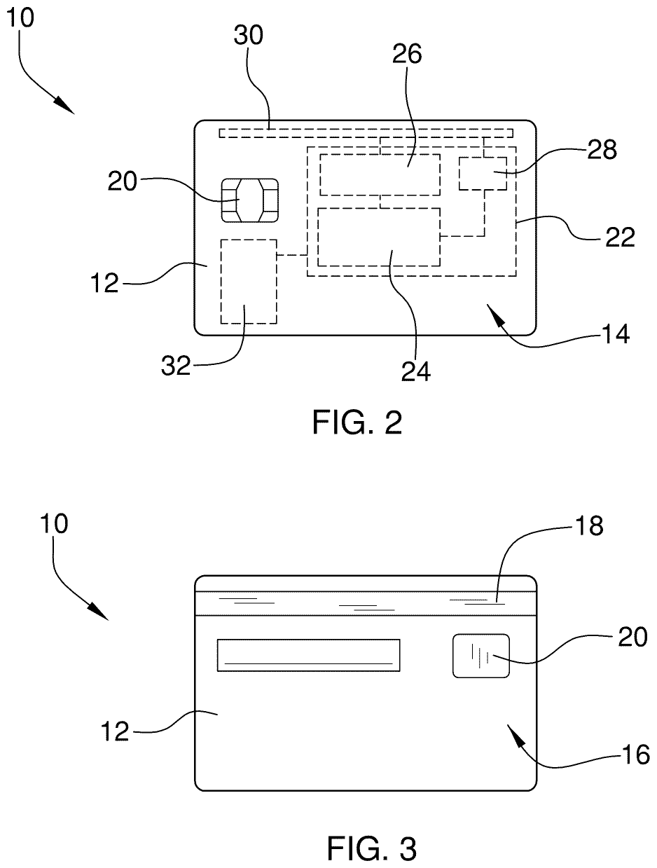

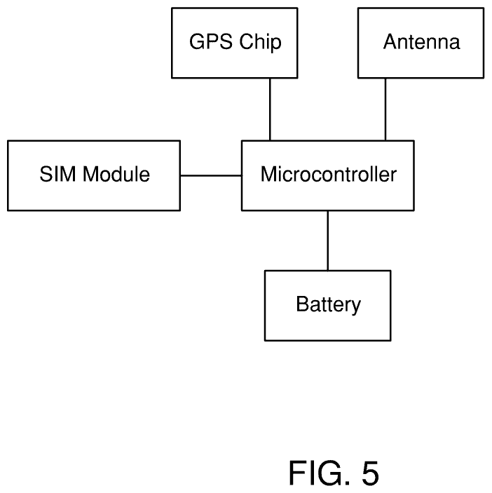

With reference now to the drawings, and in particular to FIGS. 1 through 5 thereof, a new location-trackable banking card embodying the principles and concepts of an embodiment of the disclosure and generally designated by the reference numeral 10 will be described.

As best illustrated in FIGS. 1 through 5, the location-trackable banking card 10 generally comprises a card body 12 having a front face 14 and a rear face 16. A magnetic strip 18 is attached to the rear face 16 of the card body 12. A bank card chip 20 is embedded in the card body 12. A printed circuit board 22 is positioned in the card body 12. A microcontroller 24 is positioned in the card body 12 and mounted on the printed circuit board 22. A GPS chip 26 is positioned in the card body 12 and mounted on the printed circuit board 22. The GPS chip 26 is connected to the microcontroller 24 to control intermittent operation of the GPS chip 26 to receive location data from a GPS network. A SIM module 28 is positioned in the card body 12 and mounted on the printed circuit board 22. The SIM module 28 is connected to the microcontroller 24 to control operation of the SIM module 28 to send location data over cellular networks. An antenna 30 is positioned in the card body 12 and connected to the GPS chip 26 and the SIM module 28. A battery 32 is positioned in the card body 12 and connected to the printed circuit board 22 to supply power.

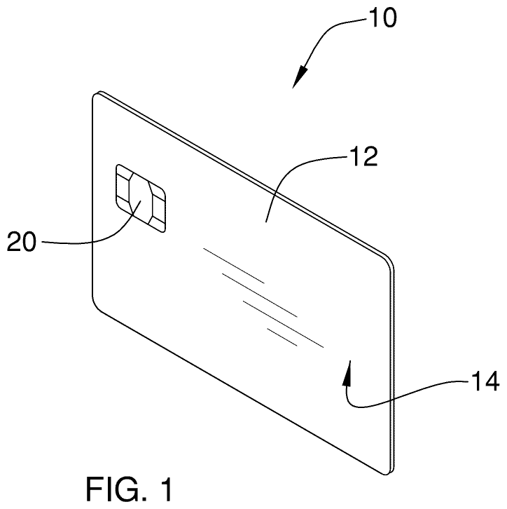

As shown in FIG. 2, all of the components must fit within a standard banking card. Most banking cards are less than 1.0 mm in thickness, such as about 0.76 mm. The dimensions of most banking cards are about 85 mm by 54 mm, though there can be some variation from these dimensions. Therefore, to avoid the banking card 10 being outside these general dimensions, the components are very thin and small in area. In the exemplary embodiment, the GPS chip 26 is less than 1.0cm² . Other dimensions, such as less than 2.0 cm² or less than 0.5 cm² are within the scope of the disclosure. The printed circuit board 22 is flexible and less than 1.0 mm thick. In another possible embodiment, the printed circuit board 22 is less than 0.75 mm thick or less than 0.5 mm thick.

The antenna 30 is a ceramic patch or printed. Such antennae are well known in the banking card technology.

In order to operate the various components, the battery 32 is needed to supply power. Most GPS chips 26 will need more than 5 milliampere-hour for brief usage, so a 10-20 milliampere-hour battery 32 is sufficient. In the exemplary embodiment, the battery 32 is 10-40 milliampere-hour. In addition, the battery 32 is lithium polymer, though other types of batteries could be used as are well known in the electrical arts.

The bank card chip 20 is a standard style that includes banking information for making purchases at a point-of-sale unit that is designed for reading bank card chips. The card body 12 can be made of plastic or other suitable materials well known in the banking card technology.

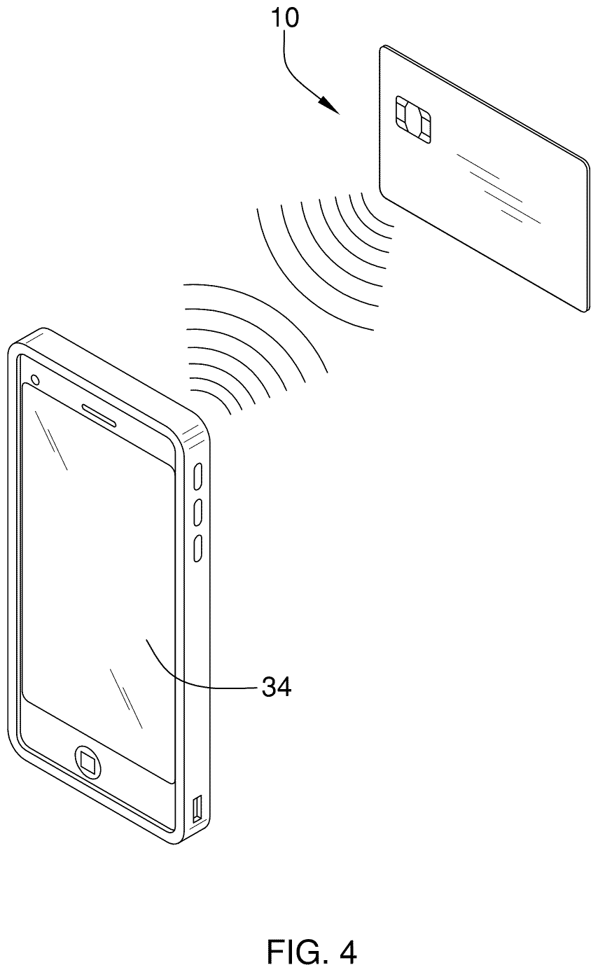

The location-trackable banking card 10 is used to track the location of the location-trackable banking card 10, such as to prevent theft and provide real-time location of a person using the location-trackable banking card 10. Since the GPS chip 26 could quickly drain the battery 32, the microcontroller 24 is designed to operate the GPS chip 26 intermittently in timed intervals to obtain location data. For example, the GPS chip 26 could briefly poll the location every 30 seconds or every minute, or possibly longer such as every five to ten minutes. In the exemplary embodiment, the microcontroller 24 is also designed to be placed in sleep mode when the microcontroller 24 is idle, such as between polling actions, in order to further reduce use of the battery 32. Once the location data is obtained by the GPS chip 26, the location data can be sent via the SIM module 28 over a cellular network to an electronic device, such as a smart phone 34 as shown in FIG. 4, or another electronic device such as a computer.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A location-trackable banking card comprising:
a card body having a front face and a rear face;
a magnetic strip being attached to said rear face of said card body;
a bank card chip being embedded in said card body;
a printed circuit board being positioned in said card body;
a microcontroller being positioned in said card body and mounted on said printed circuit board;
a GPS chip being positioned in said card body and mounted on said printed circuit board, said GPS chip being connected to said microcontroller to control intermittent operation of said GPS chip to receive location data of a location of said card body from a GPS network;
a SIM module being positioned in said card body and mounted on said printed circuit board, said SIM module being connected to said microcontroller to control operation of said SIM module to send location data over cellular networks;
an antenna being positioned in said card body and connected to said GPS chip and said SIM module; and
a battery being positioned in said card body and connected to said printed circuit board to supply power.

2. The location-trackable banking card of claim 1, wherein said GPS chip is less than 1.0cm².

3. The location-trackable banking card of claim 1, wherein said printed circuit board is flexible and less than 1.0 mm thick.

4. The location-trackable banking card of claim 1, wherein said antenna is a ceramic patch or printed.

5. The location-trackable banking card of claim 1, wherein said battery is 10-40 milliampere-hour.

6. The location-trackable banking card of claim 5, wherein said battery is lithium polymer.

7. The location-trackable banking card of claim 6, wherein said GPS chip is less than 1.0cm^{2 .}

8. The location-trackable banking card of claim 7, wherein said printed circuit board is flexible and less than 1.0 mm thick.

9. The location-trackable banking card of claim 8, wherein said antenna is a ceramic patch or printed.

10. A method of tracking a location of a banking card, said method comprising the steps of:
providing a location-trackable banking card comprising:
a card body having a front face and a rear face;
a magnetic strip being attached to said rear face of said card body;
a bank card chip being embedded in said card body;
a printed circuit board being positioned in said card body;
a microcontroller being positioned in said card body and mounted on said printed circuit board;
a GPS chip being positioned in said card body and mounted on said printed circuit board, said GPS chip being connected to said microcontroller to control intermittent operation of said GPS chip to receive location data of a location of said card body from a GPS network;
a SIM module being positioned in said card body and mounted on said printed circuit board, said SIM module being connected to said microcontroller to control operation of said SIM module to send location data over cellular networks;
an antenna being positioned in said card body and connected to said GPS chip and said SIM module; and
a battery being positioned in said card body and connected to said printed circuit board to supply power;
operating said GPS chip intermittently in timed intervals and obtaining location data; and
sending location data via said SIM module over a cellular network to an electronic device.

11. The method of claim 10, wherein said step of operating said GPS chip intermittently in timed intervals comprises polling location data every 30 to 60 seconds.

12. The method of claim 11, wherein said method further comprises placing said microcontroller in sleep mode when said microcontroller is idle.
